(19) United States
(12) Patent Application Publication
(10) Pub. No.: US 2007/0093612 A1
(43) Pub. Date: Apr. 26, 2007

(54) Composition, cured article, and associated method

(75) Inventors: Robert James Perry, Niskayuna, NY (US); Paul Burchell Glaser, Niskayuna, NY (US); Richard W. Cruse, Yorktown Heights, NY (US); Christopher Mark Hartshorn, Ossining, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/503,522

(22) Filed: Aug. 11, 2006

Related U.S. Application Data
(60) Provisional application No. 60/728,663, filed on Oct. 20, 2005.

(51) Int. Cl. C08F 8/34

(52) U.S. Cl. 525/333.9

(57) ABSTRACT

A composition is provided that includes a cross-linkable elastomeric composition; an accelerator; and a blocked mercaptosilane. The accelerator deblocks the blocked mercaptosilane when in contact therewith. An associated method and article are provided also.

### CROSS REFERENCE TO RELATED APPLICATIONS

This application claims priority and benefit to U.S. Provisional Patent Application Ser. No. 60/728/663 filed on Oct. 20, 2005. The subject matter of which is incorporated by reference herein.

### BACKGROUND

1. Technical Field

The invention includes embodiments that may relate to a composition for use as a cure package. The invention includes embodiments that may relate to a filled elastomeric composition including the cure package. The invention includes embodiments that may relate to an article formed from the filled elastomeric composition that included the cure package.

2. Discussion of Related Art

Sulfur-containing coupling agents have been used in rubber compounding. Examples of such coupling agents include silanes containing one or more of the following chemical bonds types: S—H (mercapto), S—S (disulfide or polysulfide), or C═S (thiocarbonyl). Mercaptosilanes may be used at relatively reduced load levels. Unfortunately, the use of mercaptosilanes in rubber compounding may result in unacceptably high viscosities during processing, and may result in undesirably premature curing (sometimes referred to as scorch). The mercaptosilanes may have an undesirable odor.

To address one or more of the issues associated with mercaptan use, the mercaptan moiety may be protected or blocked. Blocked mercaptosilanes have been found useful in narrow ranges relative to, and based on, the accelerator present in vulcanizable compositions.

It may be desirable to have a composition useful for coupling having one or more properties, such as relatively improved processability, reduced loading levels, and the ability to be used in less than optimal processing conditions.

### BRIEF DESCRIPTION

The invention includes embodiments that relate to a composition, comprising a cross-linkable elastomeric composition; an accelerator; and a blocked mercaptosilane. The accelerator deblocks the blocked mercaptosilane when in contact therewith.

The invention includes embodiments that relate to a method. The method includes reacting a cross-linkable elastomeric composition, an accelerator; and a blocked mercaptosilane. The accelerator deblocks the blocked mercaptosilane so that the unblocked mercaptosilane can cross link with the cross-linkable elastomeric composition.

An article is formed using the composition and/or the method including embodiments of the invention.

### DETAILED DESCRIPTION

The invention includes embodiments that may relate to a composition for use as a cure package. The invention includes embodiments that may relate to a filled elastomeric composition including the cure package. The invention includes embodiments that may relate to an article formed from the filled elastomeric composition that included the cure package.

The use of increased levels of a sulfur based accelerator, such as CBS (or similar), with a blocked mercaptosilane, such as NXT (or other thioester) in an unsaturated rubber formulation may provide a reinforced, cross-linked elastomer composition having relatively enhanced properties relative to standard and customary levels of accelerator used in rubber formulations. Such a ratio and/or amount of accelerator may be used without sacrificing scorch safety or other desired properties. NXT is commercially available from GE Silicones (Pittsfield, Mass.).

Approximating language, as used herein throughout the specification and claims, may be applied to modify any quantitative representation that could permissibly vary without resulting in a change in the basic function to which it is related. Accordingly, a value modified by a term such as “about” is not limited to the precise value specified. In some instances, the approximating language may correspond to the precision of an instrument for measuring the value.

A composition for use with a filled unsaturated elastomeric system is provided according to an embodiment of the invention. The composition may include a blocked sulfur-functional silicon-containing material and an accelerator. The blocked sulfur-functional silicon-containing material, may be, for example, a blocked mercaptosilane.

The blocked mercaptosilanes can be represented by the Formulae (1 or 2):
[[(ROC(═O))p-(G)j]k-Y—S]r-G-(SiX₃)s (1)
[(X₃Si)q-G]a-[Y—[S-G-SiX₃]b]c (2)
wherein Y may be a polyvalent species (Q)zA(=E), and may be selected from the group consisting of —C(═NR)—; —SC(═NR)—; —SC(═O)—; (—NR)C(═O)—; (—NR)C(═S)—; —OC(═O)—; OC(═S)—; —C(═O)—; —SC(═S)—; —C(═S)—; —S(═O)—; —S(═O)2-; —OS(═O)2-; (NR)S(═O)2-; SS(═O)—; —OS(═O)—; (—NR)S(═O)—; —SS(═O)2-; (—S)2P(═O)—; (S)P(═O)—; —P(═O)(−)2; (S)2P(═S)—; —(—S)P(═S)—; —P(═S)(−)2; (—NR)2P(═O)—; (—NR)(S)P(═O)—; (—O)(—NR)P(═O)—; (O)(S)P(═O)—; (—O)2P(═O)—; —(—O)P(═O)—; (NR)P(═O)—; (—NR)2P(═S)—; (NR)(S)P(═S)—; (—O)(—NR)P(═S)—; (—O)(—S)P(═S)—; (O)2P(═S)—; —(—O)P(═S)—; and (—NR)P(═S)—; each wherein the atom (A) attached to the unsaturated heteroatom (E) may be attached to the sulfur, which in turn may be linked via a group G to the silicon atom; each R may be chosen independently from hydrogen, straight, cyclic or branched alkyl that may or may not contain unsaturation, alkenyl groups, aryl groups, and aralkyl groups, with each R containing from 1 to 18 carbon atoms; each G may be independently a monovalent or polyvalent group derived by substitution of alkyl, alkenyl, aryl or aralkyl wherein G can contain from 1 to 18 carbon atoms, with the proviso that G may be not such that the silane would contain an .alpha.,.beta.-unsaturated carbonyl including a carbon-carbon double bond next to the thiocarbonyl group, and if G may be univalent (i.e., if p=0), G can be a hydrogen atom; X may be independently selected from the group consisting of —Cl, —Br, RO, RC(═O)O—, R2C═NO—, R2NO— or R2N—, —R, —(OSiR2)t(OSiR3) wherein each R and G may be as above and at least one X may be not —R; Q may be oxygen, sulfur, or (—NR—); A may be carbon, sulfur, phosphorus, or sulfonyl; E may be oxygen, sulfur, or NR; p may be 0 to 5; r may be 1 to 3; z may be 0 to 2; q may be 0 to 6; a may be 0 to 7; b may be 1 to 3; j may be 0 to 1, but it may be 0 only if p may be 1; c may be 1 to 6, preferably 1 to 4; t may be 0 to 5; s may be 1 to 3; k may be 1 to 2; with the provisos that (A) if A may be carbon, sulfur, or sulfonyl, then (i) a+b=2 and (ii) k=1; (B) if A may be phosphorus, then a+b=3 unless both (i) c>1 and (ii) b=1, in which case a=c+1; and (C) if A may be phosphorus, then k may be 2.

As used herein, “alkyl” includes straight, branched, and cyclic alkyl groups and “alkenyl” includes straight, branched, and cyclic alkenyl groups containing one or more carbon-carbon double bonds. Specific alkyls include methyl, ethyl, propyl, isobutyl, and specific aralkyls include phenyl, tolyl, and phenethyl. As used herein, “cyclic alkyl” or “cyclic alkenyl” also includes bicyclic and higher cyclic structures, as well as cyclic structures further substituted with alkyl groups. Representative examples include norbornyl, norbornenyl, ethylnorbornyl, ethylnorbornenyl, ethylcyclohexyl, ethylcyclohexenyl, and cyclohexylcyclohexyl.

Representative examples of the functional groups (—YS—) present in the silanes may include thiocarboxylate ester, —C(═O)S— (any silane with this functional group may be a “thiocarboxylate ester silane”); dithiocarboxylate, —C(═S)S— (any silane with this functional group may be a “dithiocarboxylate ester silane”); thiocarbonate ester, —O—C(═O)S— (any silane with this functional group may be a “thiocarbonate ester silane”); dithiocarbonate ester, SC(═O)S and OC(═S)S (any silane with this functional groups may be a “dithiocarbonate ester silane”); trithiocarbonate ester, SC(═S)S— (any silane with this functional group may be a “trithiocarbonate ester silane”); dithiocarbamate ester, (—N—)C(═S)S— (any silane with this functional group may be a “dithiocarbamate ester silane”); thiosulfonate ester, —S(═O)2S— (any silane with this functional group may be a “thiosulfonate ester silane”); thiosulfate ester, OS(═O)2S (any silane with this functional group may be a “thiosulfate ester silane”); thiosulfamate ester, (N—)S(═O)2S— (any silane with this functional group may be a “thiosulfamate ester silane”); thiosulfinate ester, —S(═O)S— (any silane with this functional group may be a “thiosulfinate ester silane”); thiosulfite ester, —O—S(═O)S— (any silane with this functional group may be a “thiosulfite ester silane”); thiosulfimate ester, (—N—)S(═O)—S— (any silane with this functional group may be a “thiosulfimate ester silane”); thiophosphate ester, P(═O)(O-)2(S—) (any silane with this functional group may be a “thiophosphate ester silane”); dithiophosphate ester, P(═O)(O—)(S-)2 or P(═S)(O-)2(S—) (any silane with this functional group may be a “dithiophosphate ester silane”); trithiophosphate ester, P(═O)(S-)3 or P(═S)(O—)(S-)2 (any silane with this functional group may be a “trithiophosphate ester silane”); tetrathiophosphate ester P(═S)(S-)3 (any silane with this functional group may be a “tetrathiophosphate ester silane”); thiophosphamate ester, P(═O)(N—)(S) (any silane with this functional group may be a “thiophosphamate ester silane”); dithiophosphamate ester, P(═S)(N)(S) (any silane with this functional group may be a “dithiophosphamate ester silane”); thiophosphoramidate ester, (N)P(═O)(O)(S) (any silane with this functional group may be a “thiophosphoramidate ester silane”); dithiophosphoramidate ester, (—N—)P(═O)(S-)2 or (—N—)P(═S)(O—)(S—) (any silane with this functional group may be a “dithiophosphoramidate ester silane”); trithiophosphoramidate ester, (—N—)P(═S)(S-)2 (any silane with this functional group may be a “trithiophosphoramidate ester silane”).

Suitable silanes may include those in which the Y groups may be C(═NR)—; SC(═NR)—; —SC(═O)—; —OC(═O)—; —S(═O)—; —S(═O)2-; OS(═O)2-; (NR)S(═O)2-; SS(═O)—; —OS(═O)—; —(NR)S(═O)—; —SS(═O)2-; (—S)2P(═O)—; (S)P(═O)—; P(═O)( )2; (S)2P(═S)—; —(—S)P(═S)—; —P(═S)(—)2; (—NR)2P(═O)—; (NR)(—S)P(═O)—; (O)(—NR)P(═O)—; (O)(S)P(═O)—; (—O)2P(═O)—; —(—O)P(═O)—; (NR)P(═O)—; (NR)2P(═S)—; (NR)(S)P(═S)—; (—O)(—NR)P(═S)—; (—O)(—S)P(═S)—; (O)2P(═S)—; (O)P(═S)—; and (—NR)P(═S)—. In one embodiment, the Y groups may be one or more of OC(═O) SC(═O)—; —S(═O)—; OS(═O)—; —(—S)P(═O)—; or —P(═O)(−)2.

In one embodiment, the Y may be —C(═O)—, and G has a primary carbon attached to the carbonyl and may be a C2-C12 alkyl.

In one embodiment, the silane may have the formula X₃SiGSC(═O)GC(═O)SGSiX₃ wherein G may be a divalent hydrocarbon. Suitable xamples of G include —(CH2)n- wherein n may be 1 to 12, diethylene cyclohexane, 1,2,4 triethylene cyclohexane, and diethylene benzene. The sum of the carbon atoms within the G groups within the molecule may be from 3 to 18. This amount of carbon in the blocked mercaptosilane facilitates the dispersion of the inorganic filler into the organic polymers. This may improve the balance of properties in the cured filled rubber. Suitable R groups may be alkyls of C1 to C4 and H. Specific examples of X may be methoxy, ethoxy, isobutoxy, propoxy, isopropoxy, acetoxy, and oximato. Methoxy, acetoxy, and ethoxy may be preferred. At least one X must be reactive (i.e., hydrolyzable).

In one embodiment, p may be 0 to 2; X may be RO— or RC(═O)O—; R may be hydrogen, phenyl, isopropyl, cyclohexyl, or isobutyl; G may be a substituted phenyl or substituted straight chain alkyl of C2 to C12. In exemplary embodiments, p may be zero, X may be ethoxy, and G may be a C3-C12 alkyl derivative.

Representative examples of suitable silanes may include: 2 triethoxysilyl-1-ethyl thioacetate; 2-trimethoxysilyl-1-ethyl thioacetate; 2(methyldimethoxysilyl)-1 ethyl thioacetate; 3-trimethoxysilyl-1-propyl thioacetate; triethoxysilylmethyl thioacetate; trimethoxysilylmethyl thioacetate; triisopropoxysilylmethyl thioacetate; methyldiethoxysilylmethyl thioacetate; methyldimethoxysilylmethyl thioacetate; methyldiisopropoxysilylmethyl thioacetate; dimethylethoxysilylmethyl thioacetate; dimethylmethoxysilylmethyl thioacetate; dimethylisopropoxysilylmethyl thioacetate; 2 triisopropoxysilyl-1-ethyl thioacetate; 2(methyldiethoxysilyl)-1-ethyl thioacetate; 2-(methyldiisopropoxysilyl)-1-ethyl thioacetate; 2-(dimethylethoxysilyl)-1-ethyl thioacetate; 2-(dimethylmethoxysilyl)-1-ethyl thioacetate; 2-(dimethylisopropoxysilyl)-1-ethyl thioacetate; 3-triethoxysilyl-1-propyl thioacetate; 3-triisopropoxysilyl-1-propyl thioacetate; 3-methyldiethoxysilyl-1-propyl thioacetate; 3-methyldimethoxysilyl-1-propyl thioacetate; 3 methyldiisopropoxysilyl-1-propyl thioacetate; 1-(2-triethoxysilyl-1-ethyl)-4-thioacetylcyclohexane; 1-(2-triethoxysilyl-1-ethyl)-3-thioacetylcyclohexane; 2 triethoxysilyl-5-thioacetylnorbornene; 2-triethoxysilyl-4-thioacetylnorbornene; 2(2 triethoxysilyl-1-ethyl)-5-thioacetylnorbornene; 2-(2-triethoxysilyl-1-ethyl)-4-thioacetylnorbornene; 1-(1-oxo-2-thia-5-triethoxysilylpenyl)benzoic acid; 6 triethoxysilyl-1-hexyl thioacetate; 1-triethoxysilyl-5-hexyl thioacetate; 8-triethoxysilyl-1-octyl thioacetate; 1-triethoxysilyl-7-octyl thioacetate; 6-triethoxysilyl-1-hexyl thioacetate; 1-triethoxysilyl-5-octyl thioacetate; 8-trimethoxysilyl-1-octyl thioacetate; 1-trimethoxysilyl-7-octyl thioacetate; 10-triethoxysilyl-1-decyl thioacetate; 1 triethoxysilyl-9-decyl thioacetate; 1-triethoxysilyl-2-butyl thioacetate; 1-triethoxysilyl-3-butyl thioacetate; 1-triethoxysilyl-3-methyl-2-butyl thioacetate; 1-triethoxysilyl-3-methyl-3-butyl thioacetate; 3-trimethoxysilyl-1-propyl thiooctanoate; 3-triethoxysilyl-1-propyl thiopalmitate; 3-triethoxysilyl-1-propyl thiooctanoate; 3-triethoxysilyl-1-propyl thiobenzoate; 3-triethoxysilyl-1-propyl thio-2-ethylhexanoate; 3-methyldiacetoxysilyl-1-propyl thioacetate; 3-triacetoxysilyl-1-propyl thioacetate; 2-methyldiacetoxysilyl-1-ethyl thioacetate; 2-triacetoxysilyl-1-ethyl thioacetate; 1-methyldiacetoxysilyl-1-ethyl thioacetate; 1-triacetoxysilyl-1-ethyl thioacetate; tris-(3-triethoxysilyl-1-propyl)trithiophosphate; bis-(3-triethoxysilyl-1-propyl)methyldithiophosphonate;bis-(3-triethoxysilyl-1-propyl)ethyldithiophosphonate; 3-triethoxysilyl-1-propyldimethylthiophosphinate; 3-triethoxysilyl-1-propyldiethylthiophosphinate;tris-(3-triethoxysilyl-1-propyl)tetrathiophosphate; bis-(3-triethoxysilyl-1-propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulphate; 3-triethoxysilyl-1-propylmethanethiosulphonate; 3-triethoxysilyl-1-propylethanethiosulphonate; 3-triethoxysilyl-1-propylbenzenethiosulphonate; 3-triethoxysilyl-1-propyltoluenethiosulphonate; 3-triethoxysilyl-1-propylnaphthalenethiosulphonate; 3-triethoxysilyl-1-propylxylenethiosulphonate; triethoxysilylmethylmethylthiosulphate; triethoxysilylmethylmethanethiosulphonate; triethoxysilylmethylethanethiosulphonate; triethoxysilylmethylbenzenethiosulphonate; triethoxysilylmethyltoluenethiosulphonate; triethoxysilylmethylnaphthalenethiosulphonate; and triethoxysilylmethylxylenethiosulphonate.

Mixtures of various blocked mercaptosilanes may be used, including wherein synthetic methods result in a distribution of various silanes or where mixes of blocked mercaptosilanes may be used for their various blocking or leaving functionalities. Moreover, it may be understood that the partial hydrolyzates of these blocked mercaptosilanes (i.e., blocked mercaptosiloxanes) may also be encompassed by the term blocked mercaptosilanes as used herein.

The silane, if liquid, may be loaded on a carrier, such as a porous polymer, carbon black, or silica so that it may be in solid form for delivery to the rubber.

Accelerators, or curing agents, in particular, sulfenamides, may enhance the efficiency of utilization of blocked mercaptosilanes such as thioester, in particular, thiocarboxylate silanes as coupling agents in mineral-filled rubber compositions. These agents may act simultaneously or sequentially as blocking group acceptors and as donors of sulfur groups to the blocked mercaptosilane coupling agents, and will accordingly be referred to herein as blocked mercaptosilane because the replacement of the silane blocking group by the sulfenamide sulfur group may create an in-situ derived silane during the rubber compounding process, which may be activated toward coupling to the rubber polymer. In one embodiment, the blocked mercaptosilane herein comprise any chemical compound containing at least one occurrence of the sulfenamide functional group, defined in the most general way as sulfur bound to nitrogen by an S—N chemical bond. In another embodiment, the blocked mercaptosilane may include a sulfenamide functional group, defined as sulfur bound to nitrogen by an S—N chemical bond wherein sulfur may be divalent and bound also via an S—H or S—C chemical bond to hydrogen or aliphatic carbon, respectively, and wherein nitrogen may be trivalent and bound also via N—H and/or N—C chemical bonds to hydrogen and/or aliphatic carbon, respectively. In another embodiment, the blocked mercaptosilane herein comprise at least one chemical compound having the general structure depicted by Formula 3:
(R—S-)qG (3)
wherein q may be an integer from 1 to about 20; each occurrence of R may be independently any monovalent hydrocarbon or heterocarbon group having from 1 to about 50 carbon atoms, and includes branched or straight chain alkyl, alkenyl, aryl, arenyl, or aralkyl groups; G may be chosen from the set of molecular fragments which can be obtained by substitution of a quantity, given by q, of amine N—H hydrogen atoms of any hydrogen-containing chemical structure, G, having from 1 to about 50 carbon atoms and having from 1 to about 20 nitrogen atoms; and G may be any amine-functionalized hydrocarbon or nitrogen-containing heterocarbon having from 1 to about 50 carbon atoms and having from 1 to about 20 nitrogen atoms.

In another embodiment, the blocked mercaptosilane may include at least one chemical compound having the general structure depicted by Formula 4:
(R—S-)aNR²₃-a (4)
wherein a may be an integer from 1 to 3; each occurrence of R and R2 may be independently hydrogen or any monovalent hydrocarbon or heterocarbon group having from 1 to about 50 carbon atoms, and includes branched or straight chain alkyl, alkenyl, aryl, arenyl, or aralkyl groups; and each nonhydrogen occurrence of R and R2 may be independently a terminal group on sulfur or nitrogen, respectively, or may occur externally linked to one or two other R and R2 so as to form a cyclic or even a bicyclic structure.

The term, heterocarbon, as used herein, refers to any hydrocarbon structure in which the carbon-carbon bonding backbone may be interrupted by bonding to atoms of nitrogen, sulfur, and/or oxygen; in which the carbon-carbon bonding backbone may be interrupted by bonding to groups of atoms containing nitrogen, sulfur, and/or oxygen, such as cyanurate (C₃N₃); and/or in which a hydrogen atom bound to carbon has been replaced by a terminal primary amino (—NH2) or hydroxyl (—OH) group. Thus, G includes, but may be not limited to branched, straight-chain, cyclic, and/or polycyclic aliphatic hydrocarbons, optionally containing ether functionality via oxygen atoms each of which may be bound to two separate carbon atoms, thioether functionality via sulfur atoms each of which may be bound to two separate carbon atoms, tertiary amine functionality via nitrogen atoms each of which may be bound to three separate carbon atoms, secondary amine functionality via nitrogen atoms each of which may be bound to two separate carbon atoms and a hydrogen atom, primary amine functionality via terminal —NH2 groups each of which may be bound to a carbon atom, mercaptan functionality via terminal —SH groups each of which may be bound to a carbon atom, alcohol functionality via terminal —OH groups each of which may be bound to a carbon atom, cyano (CN) groups, and/or cyanurate groups; aromatic hydrocarbons; heteroaromatics containing nitrogen, oxygen, and/or sulfur; and arenes derived by substitution of the aforementioned aromatics with branched or straight chain alkyl, alkenyl, alkynyl, aryl and/or aralkyl groups.

Representative examples of R include hydrogen, methyl, ethyl, propyl, isopropyl, sec-butyl, phenyl, benzyl, vinyl, cyclohexyl; higher straight-chain alkyl, such as butyl, hexyl, octyl, lauryl, and octadecyl; heteroaromatics, such as benzothiazolyl, benzoxazolyl, thiazolyl, benzimidazolyl, 2-benzothiazolyl, and imidazolyl. Representative examples of G include oligoamines, such as ethylene diamine, diethylene triamine, triethylene tetramine, etc., tris-aminoethylamine, bis-aminopropylamine, phenylene diamine; ethanolamines, such as ethanolamine, diethanolamine, and triethanolamine; and aminoaromatics, such as aminophenol and aminopyridine. Representative examples of the sulfenamides described herein include N-dicyclohexyl-2-benzothiazolesulfenamide, N-cyclohexyl-2-benzothiazolesulfenamide (CBS), N-oxydiethylenebenzothiazole-2-sulfenamide, dithiocarbamylsulfenamide, and N,N-diisopropylbenzothiozole-2-sulfenamide.

In one embodiment, accelerator agents, such as sulfenamides, may enhance the efficiency of utilization of blocked mercaptosilanes, such as thioester. In particular, thiocarboxylate silanes may be used as coupling agents in mineral-filled rubber compositions. These agents may act simultaneously or sequentially as blocking group acceptors and as donors of sulfur groups to the blocked mercaptosilane coupling agents, and will accordingly be referred to herein as blocked mercaptosilane activators because the replacement of the silane blocking group by the sulfenamide sulfur group create an in-situ derived silane during the rubber compounding process, which is activated toward coupling to the rubber polymer. In one embodiment, the blocked mercaptosilane activators herein comprise any chemical compound containing at least one occurrence of the sulfenamide functional group, defined in the most general way as sulfur bound to nitrogen by an S—N chemical bond. In another embodiment, the blocked mercaptosilane activators herein comprise any chemical compound containing at least one occurrence of the sulfenamide functional group, defined as sulfur bound to nitrogen by an S—N chemical bond wherein sulfur is divalent and bound also via an S—H or S—C chemical bond to hydrogen or aliphatic carbon, respectively, and wherein nitrogen is trivalent and bound also via N—H and/or N-C chemical bonds to hydrogen and/or aliphatic carbon, respectively. In another embodiment, the blocked mercaptosilane activators herein comprise at least one chemical compound having the general structure depicted by Formula 1:
(R—S-)qG Formula 1

In Formula 1, the subscript, q, is an integer from 1 to about 20; each occurrence of R is independently any monovalent hydrocarbon or heterocarbon group having from 1 to about 50 carbon atoms, and includes branched or straight chain alkyl, alkenyl, aryl, arenyl, or aralkyl groups; G is chosen from the set of molecular fragments which can be obtained by substitution of a quantity, given by q, of amine N—H hydrogen atoms of any hydrogen-containing chemical structure, G, having from 1 to about 50 carbon atoms and having from 1 to about 20 nitrogen atoms; and G is any amine-functionalized hydrocarbon or nitrogen-containing heterocarbon having from 1 to about 50 carbon atoms and having from 1 to about 20 nitrogen atoms.

In another embodiment, the blocked mercaptosilane activators herein comprise at least one chemical compound having the general structure depicted by Formula 2:
(R—S-)aNR2-a Formula 2
In Formula 2, the subscript, a, is an integer from 1 to 3; each occurrence of R and R2 is independently hydrogen or any monovalent hydrocarbon or heterocarbon group having from 1 to about 50 carbon atoms, and includes branched or straight chain alkyl, alkenyl, aryl, arenyl, or aralkyl groups; and each non-hydrogen occurrence of R and R2 is independently a terminal group on sulfur or nitrogen, respectively, or may occur externally linked to one or two other R and R2 to form a cyclic or even a bicyclic structure.

The term, heterocarbon, as used herein, refers to any hydrocarbon structure in which the carbon-carbon bonding backbone is interrupted by bonding to atoms of nitrogen, sulfur, and/or oxygen; in which the carbon-carbon bonding backbone is interrupted by bonding to groups of atoms containing nitrogen, sulfur, and/or oxygen, such as cyanurate (C₃N₃); and/or in which a hydrogen atom bound to carbon has been replaced by a terminal primary amino (—NH2) or hydroxyl (—OH) group. Thus, G includes, but is not limited to branched, straight-chain, cyclic, and/or polycyclic aliphatic hydrocarbons, optionally containing ether functionality via oxygen atoms each of which is bound to two separate carbon atoms, thioether functionality via sulfur atoms each of which is bound to two separate carbon atoms, tertiary amine functionality via nitrogen atoms each of which is bound to three separate carbon atoms, seconary amine functionality via nitrogen atoms each of which is bound to two separate carbon atoms and a hydrogen atom, primary amine functionality via terminal —NH2 groups each of which is bound to a carbon atom, mercaptan functionality via terminal —SH groups each of which is bound to a carbon atom, alcohol functionality via terminal —OH groups each of which is bound to a carbon atom, cyano (CN) groups, and/or cyanurate (C₃N₃) groups; aromatic hydrocarbons; heteroaromatics containing nitrogen, oxygen, and/or sulfur; and arenes derived by substitution of the aforementioned aromatics with branched or straight chain alkyl, alkenyl, alkynyl, aryl and/or aralkyl groups.

As used herein, alkyl includes straight, branched and cyclic alkyl groups; alkenyl includes any straight, branched, or cyclic alkenyl group containing one or more carbon-carbon double bonds, where the point of substitution can be either at a carbon-carbon double bond or elsewhere in the group; and alkynyl includes any straight, branched, or cyclic alkynyl group containing one or more carbon-carbon triple bonds and optionally also one or more carbon-carbon double bonds as well, where the point of substitution can be either at a carbon-carbon triple bond, a carbon-carbon double bond, or elsewhere in the group. Specific examples of alkyls include methyl, ethyl, propyl, and isobutyl. Specific examples of alkenyls include vinyl, propenyl, allyl, methallyl, ethylidenyl norbornane, ethylidene norbornyl, ethylidenyl norbornene, and ethylidene norbornenyl. Specific examples of alkynyls include acetylenyl, propargyl, and methylacetylenyl.

As used herein, aryl includes any aromatic hydrocarbon from which one hydrogen atom has been removed; aralkyl includes any of the aforementioned alkyl groups in which one or more hydrogen atoms have been substituted by the same number of like and/or different aryl (as defined herein) substituents; and arenyl includes any of the aforementioned aryl groups in which one or more hydrogen atoms have been substituted by the same number of like and/or different alkyl (as defined herein) substituents. Specific examples of aryls include phenyl and naphthalenyl. Specific examples of aralkyls include benzyl and phenethyl. Specific examples of arenyls include tolyl and xylyl.

As used herein, cyclic alkyl, cyclic alkenyl, and cyclic alkynyl also include bicyclic, tricyclic, and higher cyclic structures, as well as the aforementioned cyclic structures further substituted with alkyl, alkenyl, and/or alkynyl groups. Representive examples include norbornyl, norbornenyl, ethylnorbornyl, ethylnorbornenyl, ethylcyclohexyl, ethylcyclohexenyl, cyclohexylcyclohexyl, and cyclododecatrienyl.

Representative examples of R include hydrogen, methyl, ethyl, propyl, isopropyl, sec-butyl, phenyl, benzyl, vinyl, cyclohexyl; higher straight-chain alkyl, such as butyl, hexyl, octyl, lauryl, and octadecyl; heteroaromatics, such as benzothiazolyl, benzoxazolyl, thiazolyl, benzimidazolyl, 2-benzothiazolyl, and imidazolyl.

Representative examples of G0 include oligoamines, such as ethylene diamine, diethylene triamine, triethylene tetramine, etc., tris-aminoethylamine, bis-aminopropylamine, phenylene diamine; ethanolamines, such as ethanolamine, diethanolamine, and triethanolamine; and aminoaromatics, such as aminophenol and aminopyridine.

Representative examples of the sulfenamides described herein include N-dicyclohexyl-2-benzothiazolesulfenamide, N-cyclohexyl-2-benzothiazolesulfenamide (CBS), N-oxydiethylenebenzothiazole-2-sulfenamide, dithiocarbamylsulfenamide, and N,N-diisopropylbenzothiozole-2-sulfenamide.

Accelerators may be used to control the time and/or temperature required for vulcanization and to improve the properties of the vulcanizate. In one embodiment, a single accelerator system may be used as a primary accelerator. The primary accelerator may be used in total amounts in a range of from about 0.5 to about 0.8, from about 0.8 to about 1.5, and from about 1.5 to about 4 phr. Combinations of a primary and a secondary accelerator might be used with the secondary accelerator being used in smaller amounts (0.05 to 3 phr) in order to activate and to improve the properties of the vulcanizate. Delayed action accelerators may be used. Vulcanization retarders might also be used. Suitable types of accelerators may be amines, disulfides, guanidines, thioureas, thiazoles, thiurams, sulfenamides, dithiocarbamates and xanthates. The primary accelerator may be a sulfenamide. Second accelerator may include a guanidine, dithiocarbamate, or thiuram compound.

Suitable polymers may include unsaturated elastomeric compositions. Such elastomeric compositions may include solution styrene-butadiene rubber (SSBR), styrene-butadiene rubber (SBR), natural rubber (NR), polybutadiene (BR), ethylene-propylene co- and ter-polymers (EP, EPDM), and acrylonitrile-butadiene rubber (NBR). The rubber composition may be comprised of at least one diene-based elastomer, or rubber. Suitable conjugated dienes may be isoprene and 1,3-butadiene and suitable vinyl aromatic compounds may be styrene and alpha methyl styrene. The rubber may be a sulfur curable rubber. Such diene based elastomer, or rubber, may be selected, for example, from at least one of cis-1,4-polyisoprene rubber (natural and/or synthetic), and preferably natural rubber), emulsion polymerization prepared styrene/butadiene copolymer rubber, organic solution polymerization prepared styrene/butadiene rubber, 3,4-polyisoprene rubber, isoprene/butadiene rubber, styrene/isoprene/butadiene terpolymer rubber, cis-1,4-polybutadiene, medium vinyl polybutadiene rubber (35-50 percent vinyl), high vinyl polybutadiene rubber (50-75 percent vinyl), styrene/isoprene copolymers, emulsion polymerization prepared styrene/butadiene/acrylonitrile terpolymer rubber and butadiene/acrylonitrile copolymer rubber.

An emulsion polymerization derived styrene/butadiene (E-SBR) might be used having a relatively conventional styrene content of 20 to 28 percent bound styrene or, for some applications, an E-SBR having a medium to relatively high bound styrene content, namely, a bound styrene content of from about 30 to about 45 percent. Emulsion polymerization prepared styrene/butadiene/acrylonitrile terpolymer rubbers containing about 2 weight percent to about 40 weight percent bound acrylonitrile in the terpolymer may be also contemplated as diene-based rubbers for use in this invention.

The solution polymerization prepared SBR (S—SBR) may have a bound styrene content that is in a range of 5 percent to about 10 percent, from about 10 percent to about 30 percent, or from about 30 percent to about 50 percent. Polybutadiene elastomer may be characterized by a 90 weight percent cis-1,4-content.

The blocked mercaptosilane(s) may be premixed or pre reacted with the filler particles, or added to the rubber mix during the rubber and filler processing, or mixing stages. If the hydrocarbon core polysulfide silanes and filler may be added separately to the rubber mix during the rubber and filler mixing, or processing stage, it may be considered that the blocked mercaptosilane(s) then combine(s) in an in-situ fashion with the filler.

A particulate filler may also be added to the crosslinkable unsaturated elastomer compositions. Suitable filler may include siliceous fillers, carbon black, and the like. The filler materials useful herein include, but may be not limited to, carbon black and metal oxides such as silica (pyrogenic and precipitated), titanium dioxide, aluminosilicate and alumina, clays and talc, and the like. Alumina can be used either alone or in combination with silica. The term, alumina, can be described herein as aluminum oxide, or Al2O3. The fillers may be hydrated or in anhydrous form. Suitable amounts of the filler based on the combined weight of the filler and the rubber may be in a range of from about 5 to about 100 phr.

A suitable silica filler may have a BET surface area, as measured using nitrogen gas, preferably in the range of about 40 to about 50, from about 50 to about 300, or from about 300 to about 600 m²/g. The BET method of measuring surface area may be described in the Journal of the American Chemical Society, Volume 60, page 304 (1930). The silica may have a dibutylphthalate (DBP) absorption value in a range of 100 to 150, 150 to 300, or from 300 to 350. Further, the silica, alumina, or aluminosilicate may have a CTAB surface area in a range of from about 100 to about 220. The CTAB surface area may be the external surface area as evaluated by cetyl trimethylammonium bromide with a pH of 9. A suitable method is described in ASTM D 3849.

Mercury porosity surface area may be the specific surface area determined by mercury porosimetry. Using this method, mercury may be penetrated into the pores of the sample after a thermal treatment to remove volatiles. Set up conditions includes providing a 100 mg sample; removing volatiles during 2 hours at 105 degrees Celsius and ambient atmospheric pressure; ambient to about 2000 bars pressure measuring range. Such evaluation may be performed according to DIN 66133. For such an evaluation, a CARLO ERBA Porosimeter 2000 might be used. The average mercury porosity specific surface area for the silica may be in a range of from about 100 to about 300 m²/g.

A suitable pore size distribution for the silica, alumina, or aluminosilicate according to such mercury porosity evaluation may be considered herein to be such that five percent or less of its pores have a diameter of less than about 10 nm. In one embodiment, 60 percent to 90 percent of its pores have a diameter of 10 nm to 100 nm, 10 percent to 30 percent of its pores have a diameter at 100 nm to 1,000 nm, and 5 percent to about 20 percent of its pores have a diameter of greater than about 1,000 nm.

The silica may have an average ultimate particle size in a range of from about 10 nanometer (nm) to about 50 nm, about 50 nm to about 100 nm, or greater than 100 nm as determined electron microscopy. Various commercially available silica are suitable in embodiments of the invention, such as from PPG Industries under the HI SIL trademark with designations HI SIL 210, and 243; silica from Rhone Poulenc as ZEOSIL 1165MP; silica from Degussa as VN2 and VN3; and silica commercially available from Huber as HUBERSIL 8745.

In compositions for which it may be desirable to utilize siliceous fillers such as silica, alumina and/or aluminosilicates in combination with carbon black reinforcing pigments, the compositions may comprise a filler mix of from about 15 to about 98 weight percent of the siliceous filler, and about 2 to about 85 weight percent carbon black, wherein the carbon black has a CTAB value in a range of 80 to 150. Alternately, a portion of the carbon black may be a grade with extremely high surface area, up to 800 m2/gram. The weight ratio may range from about 3/1 to about 30/1 for siliceous fillers to carbon black. More typically, it may be desirable to use a weight ratio of siliceous fillers to carbon black of at least about 3/1, and preferably at least about 10/1.

Alternatively, the filler may be from about 60 weight percent to about 95 weight percent of said silica, alumina and/or aluminosilicate and, correspondingly, about 40 weight percent to about 5 weight percent carbon black. The siliceous filler and carbon black may be pre blended or blended together in the manufacture of the vulcanized rubber.

Suitable unsaturated elastomeric compositions, or rubber, may thermomechanically mixed with ingredients in a sequentially step-wise manner followed by shaping and curing the compounded rubber to form a vulcanized product. First, for the aforesaid mixing of the rubber and various ingredients, exclusive of sulfur and sulfur vulcanization accelerators (collectively “curing agents”), the rubber(s) and various rubber compounding ingredients may be blended in at least one, and often (in the case of silica filled low rolling resistance tires) two, preparatory thermomechanical mixing stage(s) in suitable mixers. Such preparatory mixing may be the nonproductive mixing or non-productive mixing steps or stages. Such preparatory mixing usually may be conducted at temperatures up to 140 degrees Celsius to about 200 degrees Celsius and often up to 150 degrees Celsius to 180 degrees Celsius

The productive mix stage may be a preparatory mix stages subsequent to such final mixing stage. A deblocking agent, curing agents, and possibly one or more additional ingredients, may be mixed with the rubber compound or composition, at a temperature in a range of 50 degrees Celsius to 130 degrees Celsius, which may be a lower temperature than the temperatures utilized in the preparatory mix stages to prevent or retard premature curing of the sulfur curable rubber, which is scorching of the rubber composition. The rubber mixture, sometimes referred to as a rubber compound or composition, may be allowed to cool, sometimes after or during a process intermediate mill mixing, between the aforesaid various mixing steps, for example, to a temperature of about 50 degrees Celsius or lower. When it may be desired to mold and to cure the rubber, the rubber may be placed into the appropriate mold at about at least 130 degrees Celsius and up to about 200 degrees Celsius, which will cause the vulcanization of the rubber by the mercapto groups on the mercaptosilane and any other free sulfur sources in the rubber mixture.

By thermomechanical mixing, the rubber compound or composition of rubber and rubber compounding ingredients may be mixed under high shear conditions to autogeneously heat as a result of the mixing primarily due to shear and associated friction within the rubber mixture in the rubber mixer. Several chemical reactions may occur at various steps in the mixing and curing processes.

The first reaction may be a relatively fast reaction and may be considered herein to take place between the filler and the SiX₃ group of the blocked mercaptosilane. Such reaction may occur at a relatively low temperature such as, for example, at about 120 degrees Celsius The second and third reactions may be considered herein to be the deblocking of the mercaptosilane and the reaction which takes place between the sulfuric part of the organosilane (after deblocking), and the sulfur vulcanizable rubber at a higher temperature; for example, above about 140 degrees Celsius.

In one embodiment, some traditional accelerator may be present in the composition. Suitable traditional accelerators may include DPG (available as PERKACIT DPG-C, Flexsys) and TMP or trimethylol propane (available from Union Carbide). In other embodiments, no traditional accelerators are present in the composition during cure.

Another sulfur source may be used, for example, in the form of elemental sulfur as S₈. A sulfur donor may be considered herein as a sulfur containing compound which liberates free, or elemental sulfur, at a temperature in a range of from about 140 degrees Celsius to 190 degrees Celsius Such sulfur donors may be, for example, although may be not limited to, polysulfide vulcanization accelerators and organosilane polysulfides with at least two connecting sulfur atoms in its polysulfide bridge. The amount of free sulfur source addition to the mixture can be controlled or manipulated as a matter of choice relatively independently from the addition of the aforesaid blocked mercaptosilane. Thus, for example, the independent addition of a sulfur source may be manipulated by the amount of addition thereof and by sequence of addition relative to addition of other ingredients to the rubber mixture.

Optional ingredients may be added to the rubber compositions. Suitable ingredients may include one or more curing aids, such as sulfur compounds; retarders, processing additives such as oils; plasticizers; tackifying resins; pigments; fatty acids; zinc oxide; waxes; antioxidants and antiozonants; peptizing agents; reinforcing material; and the like. Such additives may be selected based upon the intended use and on the sulfur vulcanizable material selected for use.

The vulcanization may be conducted in the presence of additional sulfur vulcanizing agents. Examples of suitable sulfur vulcanizing agents include, for example elemental sulfur (free sulfur) or sulfur donating vulcanizing agents, for example, an amino disulfide, polymeric polysulfide or sulfur olefin adducts which are conventionally added in the final, productive, rubber composition mixing step. The sulfur vulcanizing agents may be used, or added in the productive mixing stage, in an amount in a range of from about 0.4 phr to 3 phr.

Optional additional vulcanization accelerators, i.e., additional sulfur donors, may be used in some embodiments. Suitable donors may include, for example, benzothiazole, alkyl thiuram disulfide, guanidine derivatives and thiocarbamates. Representative of such accelerators are, for example, but not limited to, mercapto benzothiazole, tetramethyl thiuram disulfide, benzothiazole disulfide, diphenylguanidine, zinc dithiocarbamate, alkylphenoldisulfide, zinc butyl xanthate, N,N diphenylthiourea, zinc 2 mercaptotoluimidazole, dithiobis(N methyl piperazine), dithio bis (N beta hydroxy ethyl piperazine) and dithiobis(dibenzyl amine). Other additional sulfur donors may be, for example, thiuram and morpholine derivatives. Representative of such donors may include one or more of dimorpholine disulfide, dimorpholine tetrasulfide, tetramethyl thiuram tetrasulfide, benzothiazyl-2,N-dithiomorpholide, thioplasts, dipentamethylenethiuram hexasulfide, and disulfidecaprolactam.

Tackifier resins, if used, may be present in an amount in a range of from about 0.5 to about 10 phr. The processing aids may be present in an amount in a range of from 1 to about 50 phr. Such processing aids can include, for example, aromatic, napthenic, and/or paraffinic processing oils. The anti-oxidants may be present in an amount in a range of from 1 to 5 phr. Representative antioxidants may be, for example, diphenyl-p-phenylenediamine. The fatty acid may be present in an amount in a range of from about 0.5 phr to 3 phr. The zinc oxide may be present in an amount in a range of from 2 to 5 phr. The wax may be present in an amount in a range of from 1 phr to about 5 phr. Microcrystalline waxes may be used. Peptizers may be present in an amount in a range of from 0.1 phr to 1 phr. The peptizers may be, for example, pentachlorothiophenol and dibenzamidodiphenyl disulfide.

Addition of an alkyl silane to the coupling agent system (blocked mercaptosilane plus additional free sulfur source and/or vulcanization accelerator) in a mole ratio of alkyl silane to blocked mercaptosilane in a range of 1/50 to 1/2 promotes an even better control of rubber composition processing and aging.

The blocked mercaptosilanes described herein are useful as coupling agents for organic polymers (i.e., rubbers) and inorganic fillers. The blocked mercaptosilanes may show high efficiency of the mercapto group to be utilized without the detrimental side effects associated with the use of mercaptosilanes, such as high processing viscosity, less than desirable filler dispersion, premature curing (scorch), and odor. These benefits may be accomplished because the mercaptan group initially is non-reactive because of the blocking group. The blocking group may prevent the silane from coupling to the organic polymer during the compounding of the rubber. The reaction of the silane —SiX₃ group with the filler can occur at this stage of the compounding process. Coupling of the filler to the polymer may be reduced or precluded during mixing, thereby minimizing the undesirable premature curing (scorch) and the associated undesirable increase in viscosity. One can achieve better cured filled rubber properties, such as a balance of high modulus and abrasion resistance, because of the avoidance of premature curing.

The use of higher than conventional levels of primary accelerators (sulfenamide) allows for the more efficient deblocking of the blocked mercaptans which provides for more complete reaction of the sulfur functionality on the silica silane leading to higher cross-link densities, higher modulus and greater strength.

In use, one or more of the blocked mercaptosilanes are mixed with the organic polymer before, during or after the compounding of the filler into the organic polymer. The silane can be added before or during the compounding of the filler into the organic polymer because these silanes facilitate and improve the dispersion of the filler. The total amount of silane present in the resulting combination should be about 0.05 to about 25 parts by weight per hundred parts by weight of organic polymer (phr). Fillers can be used in quantities in a range of from about from about 5 to about 100 phr.

When reaction of the mixture to couple the filler to the polymer is desired, a deblocking agent is added to the mixture to deblock the blocked mercaptosilane. The deblocking agent may be added at quantities in a range of from about from about 0.1 phr to about 5 phr. If alcohol or water is present in the mixture, a catalyst (e.g., tertiary amines, Lewis acids or thiols) may be used to initiate and promote the loss of the blocking group by hydrolysis or alcoholysis to liberate the corresponding mercaptosilane. Alternatively, the deblocking agent may be a nucleophile containing a hydrogen atom sufficiently labile such that hydrogen atom could be transferred to the site of the original blocking group to form the mercaptosilane. Thus, with a blocking group acceptor molecule, an exchange of hydrogen from the nucleophile would occur with the blocking group of the blocked mercaptosilane to form the mercaptosilane and the corresponding derivative of the nucleophile containing the original blocking group. This transfer of the blocking group from the silane to the nucleophile could be driven, for example, by a greater thermodynamic stability of the products (mercaptosilane and nucleophile containing the blocking group) relative to the initial reactants (blocked mercaptosilane and nucleophile). For example, if the nucleophile includes an amine containing an N—H bond, transfer of the blocking group from the blocked mercaptosilane would yield the mercaptosilane and one of several classes of amides corresponding to the type of blocking group used. For example, carboxyl blocking groups deblocked by amines would yield amides, sulfonyl blocking groups deblocked by amines would yield sulfonamides, sulfinyl blocking groups deblocked by amines would yield sulfinamides, phosphonyl blocking groups deblocked by amines would yield phosphonamides, phosphinyl blocking groups deblocked by amines would yield phosphinamides. What is important is that regardless of the blocking group initially present on the blocked mercaptosilane and regardless of the deblocking agent used, the initially substantially inactive (from the standpoint of coupling to the organic polymer) blocked mercaptosilane is substantially converted at the desired point in the rubber compounding procedure to the active mercaptosilane. Partial amounts of the nucleophile may be used (i.e., a stoichiometric deficiency), if one were to only deblock part of the blocked mercaptosilane to control the degree of vulcanization of a specific formulation.

Aggressive nucleophiles such as amines, have a deficiency as deblocking agents as they have been shown to promote scorch of the cured elastomeric material. The sulfonamide accelerators may tend to a latency of reactivity, which promotes scorch-safe deblocking.

### EXAMPLES

The following examples are intended only to illustrate methods and embodiments in accordance with the invention, and as such should not be construed as imposing limitations upon the claims. Unless specified otherwise, all ingredients are commercially available from such common chemical suppliers as Alpha Aesar, Inc. (Ward Hill, Mass.), Spectrum Chemical Mfg. Corp. (Gardena, Calif.), and the like.

### Example 1-4

Evidence for more rapid deblocking of NXT in the presence of elevated levels of CBS is demonstrated in model reactions as described below. In a 4 dram glass vial, equipped with a small magnetic stir bar and a polyethylene cap, the ingredients listed in Table 1 are placed. Biphenyl is an internal gas chromatograph (GC) standard. The mixture is stirred and heated at 160 degrees Celsius for the amount of time indicated with aliquots removed at timed intervals for analysis. The amounts are listed in Table 1.

TABLE 1
Ingredient amounts for Examples 1-4.

| Example | NXT (mg) | NXT (mmol) | CBS (mg) | CBS (mmol) | biphenyl (mg) | Silica (g) | mesitylene (g) |
|---|---|---|---|---|---|---|---|
| 1 | 191.5 | 0.526 | 72.6 | 0.275 | 95.6 | 2.05 | 10.0 |
| 2 | 186.7 | 0.513 | 150.3 | 0.569 | 82.8 | 2.07 | 10.0 |
| 3 | 180.4 | 0.496 | 215.2 | 0.815 | 80.8 | 2.04 | 10.0 |
| 4 | 179.4 | 0.493 | 275.5 | 1.044 | 79.3 | 2.04 | 10.0 |

The reaction of CBS with the thioester resulted in the deblocking of the thioester are shown below to give the cyclohexylamide and a silane intermediate. The formation of the cycylohexylamide is monitored by GC and shown below as Structure I. Results are given in Tables 2 and 3.

TABLE 2

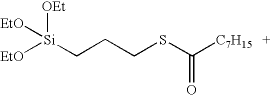

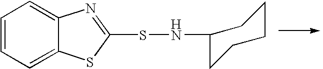

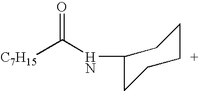

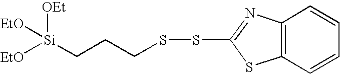

Structure I.
Cyclohexylamide percent formed.

| | Example | Example | Example | Example |
|---|---|---|---|---|
| Time (h) | 1 | 2 | 3 | 4 |
| 0.17 | 0.0 | 0.0 | 3.0 | 3.9 |
| 0.33 | 3.4 | 10.5 | 19.8 | 13.0 |
| 0.57 | 10.3 | 21.6 | 26.2 | 26.1 |
| 0.8 | 14.4 | 30.1 | 35.2 | 35.3 |
| 1.05 | 21.0 | 38.0 | 43.6 | 43.8 |
| 1.68 | 29.4 | 49.2 | 57.2 | 59.0 |
| 2.83 | 37.9 | 63.9 | 70.0 | 72.5 |
| 5.71 | 42.4 | 74.3 | 82.5 | 86.0 |

[image]

These examples indicate that both the rate of amide formation and the ultimate yield of amide formation increase with increasing levels of CBS present.

### Examples 5-7

### Use of Silanes of Ex. 5-7 in Low Rolling Resistant Tire Tread Formulation

A model low rolling resistance passenger tire tread formulation as described in Examples 5-7 and a mix procedure, are used to evaluate representative examples of the accelerator package of embodiments of the invention. The silane in Example 5 is mixed in a “B” BANBURY (Farrell Corp) mixer with a 103 cu. in. (1690 cc) chamber volume. The mixing of the rubber masterbatch is done in two steps. The mixer is turned on with the mixer at 120 rpm and the cooling water on full. The rubber polymers are added to the mixer and ram down mixed for 30 seconds. Half of the silica and all of the silane with approximately 35-40 grams of this portion of silica in an ethylvinyl acetate (EVA) bag are added and ram down mixed for 30 seconds. The remaining silica and the oil in an EVA bag are next added and ram down mixed for 30 seconds. The mixer throat is thrice dusted down and the mixture ram down mixed for 15 seconds each time. The mixer's mixing speed is increased to 160 or 240 rpm to raise the temperature of the rubber masterbatch to between 160 and 165 degrees Celsius in approximately 1 minute. The masterbatch is dumped (removed from the mixer), a sheet is formed on a roll mill set at about 50 to 60 degrees Celsius, and then allowed to cool to ambient temperature.

The rubber masterbatch is added to the mixer with the mixer at 120 rpm and cooling water turned on full and ram down mixed for 30 seconds. The remainder of the ingredients is added and ram down mixed for 30 seconds. The mixer throat is dusted down, the mixer speed increased to 160 or 240 rpm so that the contents reached a temperature between 160 and 165 degrees Celsius in approximately 2 minutes. The rubber masterbatch is mixed for 8 minutes and the speed of the BANBURY mixer is adjusted to maintain the temperature between 160 and 165 degrees Celsius the masterbatch is dumped (removed from the mixer), a sheet is formed on a roll mill set at about 50 to 60 degrees Celsius, and then allowed to cool to ambient temperature.

The rubber masterbatch and the curatives are mixed on a 6 inch by 13 inch (15 cm by 33 cm) two roll mill that is heated to between 50 and 60 degrees Celsius The sulfur and accelerators are added to the rubber masterbatch and thoroughly mixed on the roll mill and allowed to form a sheet. The sheet is cooled to ambient conditions for 24 hours before it is cured. The rheological properties are measured on a Monsanto R-100 Oscillating Disk Rheometer and a Monsanto M1400 Mooney Viscometer. The specimens for measuring the mechanical properties are cut from 6 mm plaques cured for 35 minutes at 160 degrees Celsius or from 2 mm plaques cured for 25 minutes at 160 degrees Celsius.

The following tests are conducted with the following methods (in cited examples): Mooney Scorch @ 135 degrees Celsius (ASTM Procedure D1646); Mooney Viscosity @ 100 degrees Celsius (ASTM Procedure D1646); Oscillating Disc Rheometer (ODR) @ 149 degrees Celsius, 1 degree arc, (ASTM Procedure D2084); Physical Properties, cured t90 @ 149 degrees Celsius (ASTM Procedures D412 and D224) (G″ and G″ in dynes/cm²); DIN Abrasion, mm³ (DIN Procedure 53516); and Heat Build (ASTM Procedure D623).

A fully formulated system is shown in examples 5-7. All values listed in Table 4 are in phr.

TABLE 4
Ingredients for Examples 5-7. Amounts in PHR.

| Reagent | 5 | 6 | 7 |
|---|---|---|---|
| Buna VSL 5525-1, oil extended | 103.2 | 103.2 | 103.2 |
| Budene 1207 | 25.0 | 25.0 | 25.0 |
| Zeosil 1165MP, Prec. Silica | 80.0 | 80.0 | 80.0 |
| NXT | 9.7 | 9.7 | 9.7 |
| Sundex 8125TN, Process oil | 5.0 | 5.0 | 5.0 |
| Kadox 720C, Zinc Oxide | 2.5 | 2.5 | 2.5 |
| Industrene R, Stearic Acid | 1.0 | 1.0 | 1.0 |
| Flexzone 7F, 6PPD | 2.0 | 2.0 | 2.0 |
| Sunproof Wax | 1.5 | 1.5 | 1.5 |
| N-330, Carbon Black | 3.0 | 3.0 | 3.0 |
| Sulfur | 1.4 | 1.4 | 1.4 |
| CBS | 1.70 | 2.12 | 2.55 |
| DPG | 2.0 | 2.0 | 2.0 |

Evaluation of the rubbers after curing is shown in Table 5.

TABLE 5
Evaluation results. Rheometer (ODR) Properties, (1° arc at 149° C.)

| | Example 5 | Example 6 | Example 7 |
|---|---|---|---|
| MH-M_{L} (dN-m) | 19.3 | 20.5 | 21.7 |
| t90 (min) | 14.3 | 15.4 | 16.1 |
| tₛ₁ (min) | 6.4 | 7.5 | 8.3 |
| Physical Properties, | | | |
| (cured t90 at 149° C.) | | | |
| Hardness (Shore A) | 52.2 | 54.4 | 55 |
| Tensile (MPa) | 22.5 | 22.2 | 21.4 |
| Elongation (%) | 589 | 541 | 479 |
| 100% Modulus (MPa) | 1.60 | 1.76 | 1.90 |
| 300% Modulus (MPa) | 8.46 | 9.89 | 11.17 |
| Reinforcement Index, (300%/100%) | 5.3 | 5.6 | 5.8 |

Comparative example 5 shows the results from using a standard amount of CBS accelerator. Examples 6 and 7 show that improved modulus reinforcement indicies, cross-link density and hardness improve. Not only is the modulus and reinforcement index increased, but the scorch safety also improved.

Examples 8-13 show another set of model studies looking at the effect of other additives accelerators on NXT deblocking.

TABLE 6
Amounts for Examples 8-13.

| | | | biphenyl | | | | |
|---|---|---|---|---|---|---|---|
| Example | NXT (mg) | CBS (mg) | (mg) | Silica (g) | mesitylene (g) | DPG (mg) | TMP (mg) |
| 8 | 0 | 261.3 | 155.4 | 1.00 | 10.0 | 0 | 0 |
| 9 | 362.6 | 260.7 | 152.3 | 1.00 | 10.0 | 0 | 0 |
| 10 | 0 | 0 | 160.6 | 1.00 | 10.0 | 214.1 | 0 |
| 11 | 371.1 | 0 | 152.6 | 1.00 | 10.0 | 212.5 | 0 |
| 12 | 0 | 0 | 159.5 | 1.00 | 10.0 | 0 | 132 |
| 13 | 368.1 | 0 | 147.8 | 1.00 | 10.0 | 0 | 139.6 |

Percent Consumption of Accelerator is shown in Table 7.

TABLE 7
Percent Consumption. Time value in seconds, results are in percent.

| Time | Example 8 | Example 9 | Example 10 | Example 11 | Example 12 | Example 13 |
|---|---|---|---|---|---|---|
| 0.01 | 0.0 | 0.0 | 0.0 | 0.0 | 0.0 | 0.0 |
| 0.08 | 67.6 | 46.9 | 24.5 | 27.8 | 64.4 | 100.0 |
| 0.17 | 90.1 | 62.8 | 20.4 | 28.0 | 42.2 | 32.6 |
| 0.33 | 100.0 | 84.3 | 33.8 | 31.7 | 44.8 | 39.8 |
| 0.67 | 100.0 | 73.1 | 26.8 | 40.1 | 34.2 | 35.4 |
| 1.17 | 100.0 | 100.0 | 45.7 | 57.0 | 41.6 | 63.8 |
| 5.42 | 100.0 | 100.0 | 72.4 | 97.7 | 46.7 | 63.1 |

These accelerators are examined in the presence of silica with and without NXT in the formulation. CBS is consumed more quickly in the absence of NXT than with it present. In addition, CBS is consumed much more quickly than DPG or TMP over equivalent time periods.

Examples 14-19 show further model experiments probing the effect of the accelerator on the deblocking reaction. Amounts are listed in Table 8.

TABLE 8
Amounts for Examples 14-19.

| Example | NXT (mg) | CBS (mg) | DPG (mg) | TMP (mg) | biphenyl (mg) | Silica (g) | mesitylene (g) |
|---|---|---|---|---|---|---|---|
| 14 | 185.5 | 132.1 | 0 | 0 | 81.4 | 2.00 | 10.0 |
| 15 | 184.8 | 265.0 | 0 | 0 | 77.0 | 2.00 | 10.0 |
| 16 | 182.7 | 0 | 106.2 | 0 | 74.3 | 2.00 | 10.0 |
| 17 | 184.3 | 0 | 210.4 | 0 | 77.8 | 2.00 | 10.0 |
| 18 | 184.9 | 135.9 | 106.4 | 0 | 79.3 | 2.00 | 10.0 |
| 19 | 186.2 | 0 | 0 | 133.5 | 74.9 | 2.00 | 10.0 |

Percent cyclohexylamide formed is shown in Table 9.

TABLE 9
Percent cyclohexylamide (% CyAmide) formed for Examples
14, 15 and 18.

| Example 14 | Example 15 | Example 18 |
|---|---|---|
| 0 | 0 | 0 |
| 0.00 | 0.71 | 0.00 |
| 4.09 | 3.37 | 2.85 |
| 13.08 | 14.77 | 9.12 |
| 23.07 | 25.83 | 15.29 |
| 39.17 | 39.46 | 22.28 |
| 47.50 | 49.81 | 31.08 |
| 64.35 | 65.12 | 42.64 |

The blocked mercaptosilane (NXT) is deblocked by CBS. There is no evidence of any octanoyl containing by-products from any of the DPG or TMP reactions without CBS. The CBS may deblock the protected mercaptans. Further compounding studies are shown in examples 20-32. The results indicate desirable modulus values, scorch safety, tan delta at 0 degrees Celsius and 60 degrees Celsius are obtained from runs 22 and 29 which had high levels of CBS and standard levels of DPG. Low levels of DPG resulted in t₉₀ times that are lengthened (examples 20, 23, 26, and 28). Amounts and results are listed in Table 10.

### Examples 33-49

Examples 33-49 indicate relatively properties at relatively higher CBS loadings (especially with 9.7 phr). Results are shown in Tables 11-12.

TABLE 10
Examples 20-32

| | 20 | 21 | 22 | 23 | 24 | 25 | 26 | 27 | 28 | 29 | 30 | 31 | 32 |
|---|---|---|---|---|---|---|---|---|---|---|---|---|---|
| Reagent (phr) | | | | | | | | | | | | | |
| buna VSL 5525-1, | 103.0 | 103.0 | 103.0 | 103.0 | 103.0 | 103.0 | 103.0 | 103.0 | 103.0 | 103.0 | 103.0 | 103.0 | 103.0 |
| oil extended | | | | | | | | | | | | | |
| Budene 1207 | 25.0 | 25.0 | 25.0 | 25.0 | 25.0 | 25.0 | 25.0 | 25.0 | 25.0 | 25.0 | 25.0 | 25.0 | 25.0 |
| Zeosil 1165MP, | 80.0 | 80.0 | 80.0 | 80.0 | 80.0 | 80.0 | 80.0 | 80.0 | 80.0 | 80.0 | 80.0 | 80.0 | 80.0 |
| Prec. Silica | | | | | | | | | | | | | |
| NXT | 9.7 | 9.7 | 9.7 | 9.7 | 9.7 | 9.7 | 9.7 | 9.7 | 9.7 | 9.7 | 9.7 | 9.7 | 9.7 |
| Sundex 8125TN, | 4.5 | 4.5 | 4.5 | 4.5 | 4.5 | 4.5 | 4.5 | 4.5 | 4.5 | 4.5 | 4.5 | 4.5 | 45 |
| Process oil | | | | | | | | | | | | | |
| Kadox 720C, Zinc Oxide | 2.5 | 2.5 | 2.5 | 2.5 | 2.5 | 2.5 | 2.5 | 2.5 | 2.5 | 2.5 | 2.5 | 2.5 | 2.5 |
| Industrene R, | 1.0 | 1.0 | 1.0 | 1.0 | 1.0 | 1.0 | 1.0 | 1.0 | 1.0 | 1.0 | 1.0 | 1.0 | 1.0 |
| Stearic Acid | | | | | | | | | | | | | |
| Flexzone 7F, 6PPD | 2.0 | 2.0 | 2.0 | 2.0 | 2.0 | 2.0 | 2.0 | 2.0 | 2.0 | 2.0 | 2.0 | 2.0 | 2.0 |
| Sunproof Wax | 1.5 | 1.5 | 1.5 | 1.5 | 1.5 | 1.5 | 1.5 | 1.5 | 1.5 | 1.5 | 1.5 | 1.5 | 1.5 |
| N-330, Carbon Black | 3.0 | 3.0 | 3.0 | 3.0 | 3.0 | 3.0 | 3.0 | 3.0 | 3.0 | 3.0 | 3.0 | 3.0 | 3.0 |
| Sulfur | 1.4 | 1.4 | 1.4 | 1.4 | 1.4 | 1.4 | 1.4 | 1.4 | 1.4 | 1.4 | 1.4 | 1.4 | 1.4 |
| CBS | 3.83 | 3.19 | 3.83 | 3.83 | 2.55 | 2.55 | 2.55 | 3.19 | 2.55 | 3.83 | 2.55 | 2.55 | 2.55 |
| TMP | 0.5 | 1.25 | 2.0 | 2.0 | 0.5 | 2.0 | 2.0 | 1.25 | 0.5 | 0.5 | 2.0 | 2.5 | 3.5 |
| DPG | 0.5 | 1.3 | 2.0 | 0.5 | 2.0 | 2.0 | 0.5 | 1.3 | 0.5 | 2.0 | 2.0 | 2.5 | 3.5 |

Mooney Viscosity @100° C.

| | | | | | | | | | | | | | |
|---|---|---|---|---|---|---|---|---|---|---|---|---|---|
| ML1 + 4 | 57 | 55 | 52 | 54 | 57 | 54 | 56 | 56 | 59 | 56 | 55 | 53 | 52 |

Mooney Scorch @135° C.

| | | | | | | | | | | | | | |
|---|---|---|---|---|---|---|---|---|---|---|---|---|---|
| M_{y} | 22.8 | 21.9 | 21.4 | 21.6 | 23.0 | 22.1 | 21.9 | 21.9 | 23.5 | 21.8 | 22.6 | 22.5 | 21.1 |
| MS1 +, t₃, minutes | >30 | 20.2 | 10.3 | >30 | 11.4 | 9.1 | >30 | 21.0 | >30 | 12.5 | 9.2 | 6.4 | 4.5 |
| MS1 +, t_{1B}, minutes | >30 | 24.2 | 13.0 | >30 | 15.2 | 11.4 | >30 | 24.4 | >30 | 16.2 | 11.4 | 8.3 | 6.2 |

Oscillating Disc Rheometer @ 149 ° C., 1° arc, 30 minute timer

| | | | | | | | | | | | | | |
|---|---|---|---|---|---|---|---|---|---|---|---|---|---|
| M_{L}, dNm | 8.6 | 8.4 | 8.0 | 8.2 | 8.7 | 8.5 | 8.6 | 8.4 | 9.2 | 8.6 | 8.7 | 8.4 | 8.3 |
| M_{H}, dNm | 30.5 | 31.9 | 33.8 | 32.4 | 30.4 | 31.0 | 29.5 | 32.0 | 27.0 | 33.6 | 31.0 | 30.8 | 29.0 |
| tₛ₁ , minutes | 20.0 | 10.4 | 6.2 | 17.6 | 6.4 | 5.4 | 17.1 | 10.2 | 19.5 | 7.1 | 5.5 | 4.2 | 3.2 |
| 190, minutes | 28.4 | 17.5 | 12.8 | 25.6 | 13.4 | 10.4 | 25.2 | 17.4 | 28.5 | 15.1 | 10.2 | 9.1 | 8.5 |

Physical Properties, cured t90 @ 149° C.

| | | | | | | | | | | | | | |
|---|---|---|---|---|---|---|---|---|---|---|---|---|---|
| Hardness, Shore A | 59 | 61 | 61 | 61 | 59 | 57 | 59 | 61 | 57 | 60 | 59 | 58 | 56 |
| Elongation, % | 422 | 414 | 368 | 399 | 441 | 487 | 521 | 444 | 518 | 400 | 494 | 490 | 521 |
| 25% Modulus, MPa | 0.91 | 0.93 | 0.96 | 0.94 | 0.90 | 0.85 | 0.88 | 0.92 | 0.85 | 0.93 | 0.87 | 0.88 | 0.83 |
| 100% Modulus, MPa | 2.59 | 2.56 | 2.98 | 2.85 | 2.30 | 2.25 | 2.19 | 2.57 | 2.03 | 2.77 | 2.29 | 2.30 | 2.06 |
| 300% Modulus, MPa | 14.90 | 14.29 | 16.67 | 15.68 | 12.74 | 12.68 | 11.64 | 14.20 | 11.19 | 16.14 | 12.59 | 12.91 | 11.31 |
| Tensile, MPa | 21.8 | 21.6 | 21.2 | 21.8 | 21.5 | 23.3 | 23.1 | 22.4 | 23.7 | 22.6 | 24.3 | 23.7 | 23.4 |
| Reinforcement Index | 5.75 | 5.58 | 5.59 | 5.50 | 5.54 | 5.64 | 5.32 | 5.53 | 5.51 | 5.83 | 5.50 | 5.61 | 5.49 |
| DIN Abrasion | | | | | | | | | | | | | |
| mm³ loss | 104 | 104 | 105 | 104 | 104 | 100 | 101 | 109 | 103 | 101 | 106 | 107 | 105 |
| | 102 | 104 | 106 | 98 | 107 | 105 | 98 | 105 | 103 | 106 | 103 | 108 | 106 |

Dynamic Properties in the Cured State
Non-linearity (0-10%) @ 60° C.

| | | | | | | | | | | | | | |
|---|---|---|---|---|---|---|---|---|---|---|---|---|---|
| G^{1, initial, MPa} | 3.66 | 1.95 | 2.72 | 3.18 | 2.22 | 2.19 | 3.96 | 3.53 | 3.52 | 3.10 | 2.90 | 3.44 | 2.88 |
| Delta G, MPa | 1.98 | 0.59 | 1.19 | 1.55 | 0.86 | 0.80 | 2.31 | 1.82 | 1.94 | 1.45 | 1.36 | 1.88 | 1.50 |
| G⁰ₘₐₓ₁MPA | 3.710 | 1.620 | 2.630 | 3.230 | 2.170 | 2.130 | 4.260 | 3.660 | 4.050 | 3.010 | 2.990 | 3.790 | 3.380 |
| tan deltaₘₐₓ | 0.144 | 0.099 | 0.113 | 0.134 | 0.123 | 0.118 | 0.146 | 0.130 | 0.153 | 0.124 | 0.141 | 0.136 | 0.147 |

Low Temperature Viscoelasticity

| | | | | | | | | | | | | | |
|---|---|---|---|---|---|---|---|---|---|---|---|---|---|
| tan delta, 0° C. | 0.508 | 0.671 | 0.631 | 0.545 | 0.611 | 0.613 | 0.526 | 0.554 | 0.554 | 0.629 | 0.551 | 0.581 | 0.597 |
| tan delta, 60° C. | 0.128 | 0.090 | 0.109 | 0.125 | 0.113 | 0.111 | 0.137 | 0.122 | 0.142 | 0.118 | 0.128 | 0.126 | 0.141 |
| G¹, 0° C., MPa | 7.25 | 5.15 | 6.45 | 6.18 | 5.35 | 5.56 | 6.46 | 6.47 | 6.56 | 6.59 | 6.33 | 6.80 | 6.15 |
| G⁸, 0 ° C. MPa | 3.68 | 1.72 | 2.11 | 3.36 | 1.82 | 1.83 | 3.39 | 3.58 | 3.64 | 4.15 | 3.49 | 3.95 | 3.67 |

TABLE 11
Examples 33-40
Formulation (phr); Buna VSL 5025-1 oil extended sSBR (103.2), Budene 1207 polybutadiene (25), Zeosil 1165MP
precipitated silica (80), Sundex 8125 TN process oil (5.0), Zinc Oxide 720C (2.5), Sunproof Improved Wax (1.5)
Stearic Acid Industrene R (1.5), Flexzone 7P 6PPD (2.0), N-330 Carbon black (3.0), Silane as shown

| | EXAMPLES | | | | | | | |
|---|---|---|---|---|---|---|---|---|
| | 33 | 34 | 35 | 36 | 37 | 38 | 39 | 40 |
| Silane | A-1289 | A-1289 | A-1589 | A-1589 | NXT | NXT | NXT | NXT |
| Silane (p.h.r) | 7.0 | 7.0 | 6.2 | 6.2 | 8.2 | 8.2 | 8.2 | 8.2 |
| Accelerator package | Standard | A | Standard | A | Standard | A | B | C |
| CBS (p.h.r.) | 1.7 | 3.61 | 1.7 | 3.61 | 1.7 | 3.61 | 2.98 | 4.25 |
| DPG (p.h.r.) | 2 | 2.00 | 2 | 2.00 | 2 | 2.00 | 2.00 | 2.00 |
| TMP (p.h.r.) | 0 | 0.50 | 0 | 0.50 | 0 | 0.50 | 0.50 | 0.50 |
| Mooney Properties | | | | | | | | |
| Viscosity at 100° C. (ML1 + 4) | 75.1 | 67.3 | 63.7 | 59.5 | 59.2 | 54.3 | 55.0 | 54.9 |
| MV at 135° C. (MS1+) | 35.89 | 33.24 | 27.65 | 24.99 | 23.74 | 21.36 | 22.06 | 21.92 |
| Scorch at 135° C. (MS1 + t₃) (min) | 7.2 | 6.4 | 10.0 | 10.3 | 11.0 | 14.0 | 13.0 | 14.2 |
| Cure at 135° C. (MSL+ t_{18) (mm)} | 10.03 | 10.08 | 13.41 | 14.39 | 14.41 | 17.38 | 16.36 | 18.11 |

TABLE 12
Examples 33-40

| | EXAMPLES | | | | | | | |
|---|---|---|---|---|---|---|---|---|
| | 33 | 34 | 35 | 36 | 37 | 38 | 39 | 40 |
| Rheometer (ODR) Properties, (1° arc at 149° C.) | | | | | | | | |
| M_{L} (dN-m) | 12.32 | 11.3 | 10.25 | 9.38 | 8.55 | 8.00 | 8.14 | 8.09 |
| M_{H (dN-m) (30 min. timer)} | 31.32 | 34.91 | 29.66 | 35.50 | 27.04 | 32.70 | 31.27 | 34.86 |
| t90 (mm) (30 min. timer) | 21.3 | 21.5 | 19.5 | 15.1 | 15.2 | 15.1 | 13.5 | 15.4 |
| tₛ₁(min) | 4.4 | 5.3 | 5.31 | 6.0 | 6.3 | 7.6 | 7.4 | 8.1 |
| Physical Properties, (cured t90 at 149~ C.) | | | | | | | | |
| Hardness (Shore A) | 61 | 63 | 63 | 66 | 56 | 60 | 58 | 61 |
| Tensile (MPa) | 21.64 | 19.94 | 21.37 | 20.65 | 22.11 | 21.56 | 21.86 | 22.16 |
| Elongation (%) | 510.2 | 396.0 | 599.8 | 417.7 | 615.2 | 440.1 | 502.2 | 436.2 |
| 25% Modulus (MPa) | 0.831 | 0.947 | 0.890 | 1.04 | 0.784 | 0.910 | 0.905 | 0.991 |
| 100% Modulus (MPa) | 1.76 | 2.24 | 1.61 | 2.46 | 1.59 | 2.42 | 2.10 | 2.66 |
| 300% Modulus (MPa) | 9.45 | 12.87 | 7.02 | 13.35 | 7.53 | 13.26 | 11.03 | 14.12 |
| Reinforcement Index, (300%/25%) | 11.37 | 13.59 | 7.89 | 12.84 | 9.60 | 14.57 | 12.19 | 14.25 |
| Reinforcement Index, (300%/100%) | 5.38 | 5.75 | 4.36 | 5.43 | 4.74 | 5.48 | 5.25 | 5.31 |

TABLE 13
Examples 41-49
Formulation (phr) Buna VSL 5025-1 oil extended sSBR (103.2), Budene 1207 polybutadiene (25), Zeosil 1 165MP
precipitated silica (80), Sundex 8125 TN process oil (5.0), Zinc Oxide 720C (2.5), Sunproof Improved Wax (1.5)
stearic Acid Industrene R (1.5), Flexzone 7P 6PPD (2.0), N-330 Carbon black (3.0), Silane as shown

| | EXAMPLES | | | | | | | | |
|---|---|---|---|---|---|---|---|---|---|
| | 41 | 42 | 43 | 44 | 45 | 46 | 47 | 48 | 49 |
| Silane | NXT | NXT | NXT | NXT | NXT | NXT | NXT | NXT | NXT |
| Silane (p.h.r) | 8.2 | 8.2 | 8.2 | 9.7 | 9.7 | 9.7 | 9.7 | 9.7 | 9.7 |
| Accelerator package | D | A | E | Standard | A | B | C | D | A |
| CBS (p.h.r.) | 3.61 | 3.61 | 5.94 | 1.7 | 3.61 | 2.98 | 4.25 | 3.61 | 3.61 |
| DPG (p.h.r.) | 1.30 | 2.00 | 2.00 | 2 | 2.00 | 2.00 | 2.00 | 1.30 | 2.00 |
| TMP (p.h.r.) | 0.50 | 0.50 | 0.50 | 0 | 0.50 | 0.50 | 0.50 | 0.50 | 0.50 |
| Mooney Properties | | | | | | | | | |
| Viscosity at 100° C. (ML1 + 4) | 55.9 | 54.7 | 51.4 | 55.9 | 52.0 | 53.5 | 52.7 | 54.6 | 53.6 |
| MV at 135° C. (MS1+) | 22.90 | 22.90 | 20.81 | 22.76 | 21.08 | 22.76 | 23.18 | 24.16 | 21.22 |
| Scorch at 135° C. (MS1 + t₃) | 23.1 | 13.4 | 15.1 | 12.3 | 14.5 | 13.3 | 14.2 | 22.5 | 14.4 |
| (min) | | | | | | | | | |
| Cure at 135° C. (MS1 + t₁₈) | 27.52 | 17.3 | 18.3 | 15.5 | 17.5 | 16.4 | 17.2 | 26.5 | 17.5 |
| (min) | | | | | | | | | |
| Rheometer (ODR) Properties, | | | | | | | | | |
| (1° arc at 149° C.) | | | | | | | | | |
| M_{L} (dN-m) | 8.18 | 8.09 | 7.72 | 8.23 | 7.77 | 8.09 | 8.00 | 8.04 | 8.09 |
| M_{H} (dN-m) (30 mm. timer) | 32.65 | 33.39 | 37.53 | 27.23 | 33.02 | 32.01 | 35.00 | 33.16 | 33.34 |
| t90 (min) (30 mm. timer)19.3 | 14.4 | 17.3 | 13.2 | 14.3 | 13.4 | 15.1 | 19.2 | 14.4 | |
| tₛ₁ (min) | 12.1 | 8.0 | 8.3 | 8.2 | 8.1 | 7.4 | 8.1 | 12.1 | 8.1 |
| Physical Properties, | | | | | | | | | |
| (cured t90 at 149° C.) | | | | | | | | | |
| Hardness (Shore A) 59 | 59 | 61 | 56 | 59 | 57 | 62 | 59 | 59 | |
| Tensile (MPa) | 20.69 | 22.06 | 21.22 | 21.79 | 21.29 | 21.76 | 19.52 | 21.03 | 20.50 |
| Elongation (%) | 445.0 | 480.2 | 376.4 | 643.7 | 458.1 | 507.4 | 371.7 | 455.8 | 444.9 |
| 25% Modulus (MPa) 0.921 | 0.894 | 0.972 | 0.723 | 0.785 | 0.884 | 0.959 | 0.799 | 0.796 | |
| 100% Modulus (MPa) | 2.30 | 2.25 | 2.81 | 1.54 | 2.25 | 2.15 | 2.66 | 2.17 | 2.28 |
| 300% Modulus (MPa) | 12.45 | 12.18 | 15.64 | 7.38 | 12.70 | 11.38 | 14.69 | 11.95 | 12.97 |
| Reinforcement Index, | | | | | | | | | |
| (300%/25%) | 13.52 | 13.62 | 16.09 | 10.21 | 16.18 | 12.87 | 15.32 | 14.96 | 16.29 |
| Reinforcement Index, | 5.41 | 5.41 | 5.57 | 4.79 | 5.64 | 5.29 | 5.52 | 5.51 | 5.69 |
| (300%/100%) | | | | | | | | | |

In one embodiment, a relatively increased loading of accelerator and/or blocked mercaptosilane may be used to increase and/or enhance physical properties of the vulcanizate without, or with reduced amounts and/or risk of, scorching or premature curing.

In one embodiment, accelerator, such as sulfinamide type accelerators, may be used to de block a blocked mercaptosilane. Thus, blocked mercaptosilane materials may be used in the absence of traditional deblocking agents, such as DPG and/or TMP. In one embodiment, the quantity and/or ratio of the accelerator may be increased to compensate for the absence (or reduced amounts of) the deblocking agent.

Similarly, two or more different accelerators may be used together. One accelerator may perform the expected accelerator function, but the other accelerator may deblock a blocked mercaptosilane at a different rate relative to the first accelerator. Thus, materials used for accelerators may be used to compliment, or replace entirely, deblocking agents. And, the choice and selection of the accelerators in the combination of accelerators may allow for control of the cure profile of the vulcanizable material.

In one embodiment, the amount of accelerator present in the uncured filled elastomer may be in a range of from about 2 phr to about 4 phr. The amount may be in a range of greater than about 8 phr. In one embodiment, the amount present may be in a range of about 4 phr to about 8 phr, from about 8 phr to about 10 phr, from about 10 to about 12 phr, or from about 12 phr to about 15 phr.

Throughout the specification range limitations may be combined and/or interchanged, such ranges are identified and include all the sub-ranges contained therein unless context or language indicates otherwise. This written description may enable those of ordinary skill in the art to make and use embodiments having alternative elements. The scope includes compositions, structures, systems and methods that do not differ from the literal language of the disclosed embodiments, and further includes other structures, systems and methods with insubstantial differences from the literal language of the disclosed embodiments. While only certain features and embodiments have been illustrated and described herein, many modifications and changes may occur to one of ordinary skill in the relevant art.

1. A composition, comprising:
a cross-linkable elastomeric composition;
a blocked mercaptosilane; and
an accelerator that is capable of deblocking the blocked mercaptosilane when in contact therewith.

2. The composition as defined in claim 1, wherein the accelerator comprises a sulfinamide type accelerator.

3. The composition as defined in claim 2, wherein the composition is entirely free of deblocking agents other than the accelerator.

4. The composition as defined in claim 1, wherein the composition has less than 0.1 weight percent of any one of the materials selected from the group consisting of N,N′-diphenylguanidine; N,N′,N″-triphenylguanidine; N,N′-di-ortho-tolylguanidine; ortho-biguanide; hexamethylenetetramine; cyclohexylethylamine; dibutylamine; and 4,4′-diaminodiphenylmethane.

5. The composition as defined in claim 1, wherein the accelerator comprises a plurality of accelerators, and at least one of the plurality is capable to deblock the blocked mercaptosilane and at least one other of the plurality is not capable to deblock the blocked mercaptosilane.

6. The composition as defined in claim 1, wherein the accelerator is present in an amount in a range of from about 1 phr to about 4 phr.

7. The composition as defined in claim 1, wherein the accelerator is present in an amount in a range of about 4 phr to about 8 phr.

8. The composition as defined in claim 1, wherein the accelerator is present in an amount in a range of from about 8 phr to about 10 phr.

9. The composition as defined in claim 1, wherein the accelerator is present in an amount in a range of from about 10 to about 12 phr.

10. The composition as defined in claim 1, wherein the accelerator is present in an amount in a range of from about 12 phr to about 15 phr.

11. The composition as defined in claim 1, further comprising one or more material selected from the group consisting of 2 triethoxysilyl-1-ethyl thioacetate; 2-trimethoxysilyl-1-ethyl thioacetate; 2(methyldimethoxysilyl)-1 ethyl thioacetate; 3-trimethoxysilyl-1-propyl thioacetate; triethoxysilylmethyl thioacetate; trimethoxysilylmethyl thioacetate; triisopropoxysilylmethyl thioacetate; methyldiethoxysilylmethyl thioacetate; methyldimethoxysilylmethyl thioacetate; methyldiisopropoxysilylmethyl thioacetate; dimethylethoxysilylmethyl thioacetate; dimethylmethoxysilylmethyl thioacetate; dimethylisopropoxysilylmethyl thioacetate; 2 triisopropoxysilyl-1-ethyl thioacetate; 2(methyldiethoxysilyl)-1-ethyl thioacetate; 2-(methyldiisopropoxysilyl)-1-ethyl thioacetate; 2-(dimethylethoxysilyl)-1-ethyl thio acetate; 2-(dimethylmethoxysilyl)-1-ethyl thioacetate; 2-(dimethylisopropoxysilyl)-1-ethyl thioacetate; 3-triethoxysilyl-1-propyl thioacetate; 3-triisopropoxysilyl-1-propyl thioacetate; 3-methyldiethoxysilyl-1-propyl thioacetate; 3-methyldimethoxysilyl-1-propyl thioacetate; 3 methyldiisopropoxysilyl-1-propyl thioacetate; 1-(2-triethoxysilyl-1-ethyl)-4-thioacetylcyclohexane; 1-(2-triethoxysilyl-1-ethyl)-3-thioacetylcyclohexane; 2 triethoxysilyl-5-thioacetylnorbornene; 2-triethoxysilyl-4-thioacetylnorbornene; 2(2 triethoxysilyl-1-ethyl)-5-thioacetylnorbornene; 2-(2-triethoxysilyl-1-ethyl)-4-thioacetylnorbornene; 1-(1-oxo-2-thia-5-triethoxysilylpenyl)benzoic acid; 6 triethoxysilyl-1-hexyl thioacetate; 1-triethoxysilyl-5-hexyl thioacetate; 8-triethoxysilyl-1-octyl thioacetate; 1-triethoxysilyl-7-octyl thioacetate; 6-triethoxysilyl-1-hexyl thioacetate; 1-triethoxysilyl-5-octyl thioacetate; 8-trimethoxysilyl-1-octyl thioacetate; 1-trimethoxysilyl-7-octyl thioacetate; 10-triethoxysilyl-1-decyl thioacetate; 1 triethoxysilyl-9-decyl thioacetate; 1-triethoxysilyl-2-butyl thioacetate; 1-triethoxysilyl-3-butyl thioacetate; 1-triethoxysilyl-3-methyl-2-butyl thioacetate; 1-triethoxysilyl-3-methyl-3-butyl thioacetate; 3-trimethoxysilyl-1-propyl thiooctanoate; 3-triethoxysilyl-1-propyl thiopalmitate; 3-triethoxysilyl-1-propyl thiooctanoate; 3-triethoxysilyl-1-propyl thiobenzoate; 3-triethoxysilyl-1-propyl thio-2-ethylhexanoate; 3-methyldiacetoxysilyl-1-propyl thioacetate; 3-triacetoxysilyl-1-propyl thioacetate; 2-methyldiacetoxysilyl-1-ethyl thioacetate; 2-triacetoxysilyl-1-ethyl thioacetate; 1-methyldiacetoxysilyl-1-ethyl thioacetate; 1-triacetoxysilyl-1-ethyl thioacetate; tris-(3-triethoxysilyl-1-propyl)trithiophosphate; bis-(3-triethoxysilyl-1-propyl)methyldithiophosphonate;bis-(3-triethoxysilyl 1-propyl)ethyldithiophosphonate; 3-triethoxysilyl-1-propyldimethylthiophosphinate; 3-triethoxysilyl-1-propyldiethylthiophosphinate;tris-(3-triethoxysilyl-1-propyl)tetrathiophosphate; bis-(3-triethoxysilyl-1-propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulphate;3-triethoxysilyl-1-propylmethanethiosulphonate; 3-triethoxysilyl-1-propylethanethiosulphonate; 3-triethoxysilyl-1-propylbenzenethiosulphonate; 3-triethoxysilyl-1-propyltoluenethiosulphonate; 3-triethoxysilyl-1-propylnaphthalenethiosulphonate; 3-triethoxysilyl-1-propylxylenethiosulphonate; triethoxysilylmethylmethylthiosulphate; triethoxysilylmethylmethanethiosulphonate; triethoxysilylmethylethanethiosulphonate; triethoxysilylmethylbenzenethiosulphonate; triethoxysilylmethyltoluenethiosulphonate; triethoxysilylmethylnaphthalenethiosulphonate; and triethoxysilylmethylxylenethiosulphonate

12. The composition as defined in claim 1, wherein the blocked mercaptosilanes is represented by the Formulae (1 or 2):
[[(ROC(═O))p-(G)j]k-Y—S]r-G-(SiX₃)s (1)
[(X₃Si)q-G]a-[Y—[S-G-SiX₃]b]c (2)
wherein Y is a polyvalent species (Q)zA(=E) selected from the group consisting of —C(═NR)—; —SC(═NR)—; —SC(═O)—; (—NR)C(═O)—; (—NR)C(═S)—; —OC(═O)—; OC(═S)—; —C(═O)—; —SC(═S)—; —C(═S)—; —S(═O)—; —S(═O)2-; —OS(═O)2-; (NR)S(═O)2-; SS(═O)—; —OS(═O)—; (—NR)S(═O)—; —SS(═O)2-; (—S)2P(═O)—; (S)P(═O)—; —P(═O)(—)2; (S)2P(═S)—; —(—S)P(═S)—; —P(═S)(—)2; (—NR)2P(═O)—; (NR)(S)P(═O)—; (—O)(—NR)P(═O)—; (O)(S)P(═O)—; (—O)2P(═O)—; —(—O)P(═O)—; (NR)P(═O)—; (—NR)2P(═S)—; (NR)(S)P(═S)—; (—O)(—NR)P(═S)—; (—O)(—S)P(═S)—; (O)2P(═S)—; —(—O)P(═S)—; and (—NR)P(═S)—;
wherein the atom (A) attached to the unsaturated heteroatom (E) is attached to the sulfur, which in turn is linked via a group G to the silicon atom; each R is independently selected from the group consisting of hydrogen, straight alkyl groups, cyclic alkyl groups, and branched alkyl groups; each R contains from 1 to 18 carbon atoms; each G is independently a monovalent or polyvalent group derived by substitution of alkyl, alkenyl, aryl or aralkyl wherein G contains from 1 to 18 carbon atoms, with the proviso that G is not such that the silane would contain an unsaturated carbonyl including a carbon-carbon double bond next to the thiocarbonyl group, and if G may be univalent (i.e., if p=0), G can be a hydrogen atom;
X is independently selected from the group consisting of —Cl, —Br, RO, RC(═O)O—, R2C═NO—, R2NO— or R2N—, —R, -—OSiR2)t(OSiR3);
Q is independently selected from the group consisting of oxygen, sulfur, and (—NR—);
A is independently selected from the group consisting of carbon, sulfur, phosphorus, and sulfonyl;
E is independently selected from the group consisting of oxygen, sulfur, and NR;
p is 0 to 5; r is 1 to 3; z is 0 to 2; q is 0 to 6; a is 0 to 7; b is 1 to 3; j is 0 to 1, but it is 0 only if p is 1; c is 1 to 6; t is 0 to 5; s is 1 to 3; k is 1 to 2; with the provisos that if A is carbon, sulfur, or sulfonyl, then (i) a+b=2 and (ii) k=1; if A is phosphorus, then a+b=3 unless both (i) c>1 and (ii) b=1, in which case a=c+1; and if A is phosphorus, than k is 2.

13. The composition as defined in claim 1, wherein the accelerator comprises one or more material selected from the group consisting of N-dicyclohexyl-2-benzothiazolesulfenamide, N-cyclohexyl-2-benzothiazolesulfenamide, N-oxydiethylenebenzothiazole-2-sulfenamide, dithiocarbamylsulfenamide, and N,N-diisopropylbenzothiozole-2-sulfenamide.

14. The composition as defined in claim 13, wherein the accelerator comprises N-cyclohexyl-2-benzothiazolesulfenamide.

15. The composition as defined in claim 14, wherein the accelerator consists essentially of N-cyclohexyl-2-benzothiazolesulfenamide.

16. A cured rubber article formed as the reaction product of the composition as defined in claim 1.

17. The article defined in claim 16 have less than 0.5 percent scorch.

18. A method, comprising:
reacting a cross-linkable elastomeric composition, an accelerator; and a blocked mercaptosilane, wherein the accelerator deblocks the blocked mercaptosilane so that the unblocked mercaptosilane can cross link with the cross-linkable elastomeric composition.

19. The method as defined in claim 18, wherein the reacting is done in the absence of water and the absence of alcohol.

20. The method as defined in claim 18, wherein the accelerator comprises N-cyclohexyl-2-benzothiazolesulfenamide and the blocked mercaptosilane comprises a thioester group.
